(19) United States
(12) Patent Application Publication
(10) Pub. No.: US 2016/0109820 A1
(43) Pub. Date: Apr. 21, 2016

(54) TONER

(71) Applicant: CANON KABUSHIKI KAISHA, Tokyo (JP)

(72) Inventors: Takeshi Hashimoto, Moriya-shi (JP); Hiroyuki Fujikawa, Yokohama-shi (JP); Nozomu Komatsu, Toride-shi (JP); Hideki Kaneko, Yokohama-shi (JP); Yosuke Iwasaki, Abiko-shi (JP); Ichiro Kanno, Abiko-shi (JP)

(21) Appl. No.: 14/977,470

(22) Filed: Dec. 21, 2015

Related U.S. Application Data
(62) Division of application No. 13/867,398, filed on Apr. 22, 2013.

(30) Foreign Application Priority Data
Apr. 27, 2012 (JP) 2012-102021

(51) Int. Cl. G03G 9/087; G03G 9/08

(52) U.S. Cl. CPC G03G 9/08755; G03G 9/08706; G03G 9/08704; G03G 9/0827; G03G 9/0815

(57) ABSTRACT

Provided is a toner that has excellent low-temperature fixability, hot offset resistance, high image glossiness and fixing wraparound resistance, as well as high durable stability. The toner includes toner particles that contain a binder resin, a colorant and a wax, and fine inorganic particles on a surface of the toner particles, wherein the binder resin contains a polyester resin A and a styrene resin B, and a content ratio A/B of the polyester resin A and the styrene resin B is 85/15 or more and 98/2 or less based on mass, the styrene resin B has a weight average molecular weight Mw of a tetrahydrofuran soluble component of 2,000 or more and 5,000 or less, and the toner has been subjected to a hot-air surface treatment.

### BACKGROUND OF THE INVENTION

1. Field of the Invention

The present invention relates to a toner that is used in an electrophotographic method, an electrostatic recording method, an electrostatic printing method and a toner jet method.

2. Description of the Related Art

Recently, print-on-demand (POD) has been drawing attention. This digital printing technology directly performs printing without going through a plate making step. Consequently, POD can handle demands for small lot printing and short delivery times. Further, since POD can also handle printing in which the content changes for each sheet (variable printing), and dispersed printing that activates a plurality of output machines from one piece of data by utilizing a communication function, POD has advantages over conventional offset printing.

To apply an image forming method that employs an electrophotographic method in the POD market, in addition to improved image quality, it is necessary to reduce energy consumption of the electrophotographic apparatus, handle high-speed printing of 100 or more sheets per minute, and handle mixed media that include various recording sheets, such as plain paper, thick paper and coated paper.

As a method for reducing the energy consumption of an electrophotographic apparatus, technology that fixes at a lower fixing temperature in order to reduce power consumption during the fixing step is being investigated. To achieve this, it is desirable to use a resin having a sharper melt property. As a resin having a sharp melt property, polyester resin is being used.

Although a toner that uses a polyester resin has a certain effect on low-temperature fixability, the problems are that hot offset occurs, and that the paper wraps around the fixing member.

To resolve hot offset, a toner that maintains elasticity at a high temperature region is known to be effective. However, such a toner causes the gloss of the printed image to deteriorate.

Investigations have been made into increasing the content of wax in the toner so that the toner has a low elasticity enough not to cause the gloss of the printed image to deteriorate, and to suppress hot offsets and paper wraparound.

However, polyester resin has poor wax dispersibility, so that if the wax content in the toner is high, clumps of wax can form in the toner, causing durability to deteriorate. For example, image defects such as white streaks were caused in an image that had been continuously printed on 1,000 sheets at a low printing ratio under an ordinary-temperature, low-humidity environment.

In order to achieve both hot offset resistance and printed image gloss with a toner that mainly contains a polyester resin as a binder resin, an invention has been disclosed that also uses a resin other than polyester. Japanese Patent Application Laid-Open Nos. 2002-82488 and 2002-258530 disclose a toner that combines a polyester resin and a styrene resin. Further, Japanese Patent Application Laid-Open No. 2002-162777 discloses a toner that combines a polyolefin resin and a polyester resin that is a copolymer of a styrene monomer, an acrylic monomer and an acrylonitrile monomer.

Although such toners have a certain effect on hot offset suppression and gloss maintenance, the combination of hot offset suppression and gloss maintenance in high-speed printing of 100 or more sheets per minute is still not sufficient, and neither is durable stability. Further, when continuous printing is performed at high speed in which in one job there is mixed media that include recording sheets with a high grammage, like thick paper, and recording sheets with a low grammage, like plain paper, even if the temperature of the fixing member is identical, the temperature of the transferred unfixed toner will be different due to differences in the heat capacity of the recording sheets. Consequently, the phenomenon of hot offsets occurs for the plain paper with a low grammage, and thus there is a need to resolve this problem.

### SUMMARY OF THE INVENTION

An object of the present invention is to providing a toner that resolves the above-described problems.

Specifically, the present invention is directed to providing a toner that has excellent low-temperature fixability, hot offset resistance, high image glossiness and fixing wraparound resistance, as well as high durable stability.

Especially, the present invention is directed to providing a toner capable of forming a good image, in which the above-described problems do not occur even when performing high-speed printing using mixed media that include papers having remarkably different grammages.

The present invention relates to a toner including toner particles, each of which contains a binder resin, a colorant and a wax, and fine inorganic particles on a surface of the toner particles, wherein the binder resin contains a polyester resin A and a styrene resin B, and a content ratio A/B of the polyester resin A and the styrene resin B is 85/15 or more and 98/2 or less based on mass, the styrene resin B has a weight average molecular weight Mw of a tetrahydrofuran soluble component of 2,000 or more and 5,000 or less, and the toner particles have been subjected to a surface treatment by hot-air.

Further features of the present invention will become apparent from the following description of exemplary embodiments with reference to the attached drawings.

### BRIEF DESCRIPTION OF THE DRAWINGS

FIG. 1 is a schematic diagram illustrating a flow in a toner surface heat-treatment apparatus.

FIGS. 2A, 2B and 2C are schematic diagrams illustrating an example of a surface heat-treatment apparatus.

FIG. 3 is a partial cross-sectional perspective view illustrating an example of a hot-air supply unit and an airflow adjustment unit.

FIG. 4 is a partial cross-sectional perspective view illustrating an example of a cold-air supply unit and an airflow adjustment unit.

### DESCRIPTION OF THE EMBODIMENTS

Preferred embodiments of the present invention will now be described in detail in accordance with the accompanying drawings.

The mechanism by which the effects are exhibited in the present invention is thought to be as follows.

During high-speed printing (e.g., during printing at faster than 100 sheets per minute), the melting time of the toner in the fixing step shortens. To perform good fixing during such high-speed printing, when the toner comes into contact with the fixing member and is subjected to heat and pressure, it is necessary for the a large amount of the wax in the toner to bleed onto the toner surface in a short time.

For that to occur, it is thought that both the bleeding speed of the melted wax onto the surface needs to be faster and the wax needs to be present near the surface.

The binder resin contained in the toner according to the present invention contains a polyester resin A and a styrene resin B. The styrene resin is a resin having a higher affinity with the wax than the polyester resin and having excellent dispersibility of the wax in the resin. Further, a styrene resin component like that used in the present invention, which has a weight average molecular weight Mw of the tetrahydrofuran soluble matter of 2,000 to 5,000, is a component that is easily melted during fixing. Due to the presence of such a styrene resin in the toner, during fixing, the styrene resin B quickly melts, so that the wax easily bleeds onto the toner surface. It is believed that this is the reason why the bleeding speed of the wax from the toner increases.

Further, the toner according to the present invention is subjected to a hot-air surface treatment. By carrying out the hot-air surface treatment, the wax in the pre-treatment particles moves toward the particle surface. Consequently, the amount of wax present near the surface of the toner particles is greater than for a toner produced without performing a hot-air treatment.

Thus, in the present invention, by combining the styrene resin B with a surface treatment by hot-air, it is thought that a large amount of wax can be present at the toner surface in a short time during the fixing step, so that a hot offset suppressing effect can be exhibited during high-seed printing.

Further, the toner according to the present invention is also characterized by including the polyester resin A as a binder resin. The polyester resin A has a sharp melt property that is advantageous in realizing low-temperature fixing. In the present invention, the polyester resin A may have a peak molecular weight Mp of a tetrahydrofuran soluble component of 2,500 or more and 6,000 or less and a glass transition temperature Tg of 40° C. or more and less than 70° C. In such a case, the low-temperature fixability is increased more.

Specific examples of the component forming the polyester resin A include a divalent or higher alcohol monomer component and an acid monomer component of a divalent or higher carboxylic acid, a divalent or higher carboxylic acid anhydride and a divalent or higher carboxylic acid ester.

Examples of the divalent alcohol monomer component include alkylene oxide adducts of bisphenol A, such as polyoxypropylene (2.2)-2,2-bis(4-hydroxyphenyl)propane, polyoxypropylene (3.3)-2,2-bis(4-hydroxyphenyl)propane, polyoxyethylene (2.0)-2,2-bis(4-hydroxyphenyl)propane, polyoxypropylene (2.0)-polyoxyethylene (2.0)-2,2-bis(4-hydroxyphenyl)propane and polyoxypropylene (6)-2,2-bis(4-hydroxyphenyl)propane, ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, polytetramethylene glycol, bisphenol A and hydrogenated bisphenol A.

Examples of a trivalent or higher alcohol monomer component include sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylol ethane, trimethylol propane and 1,3,5-trihydroxy methyl benzene.

Examples of a divalent carboxylic acid monomer component include aromatic dicarboxylic acids or anhydrides thereof, such as phthalic acid, isophthalic acid and terephthalic acid; alkyl dicarboxylic acids or anhydrides thereof such as succinic acid, adipic acid, sebacic acid and azelaic acid; succinic acid or an anhydride thereof substituted with an alkyl group or an alkenyl group having 6 to 18 carbon atoms; and unsaturated dicarboxylic acids or anhydrides thereof, such as fumaric acid, maleic acid and citraconic acid.

Examples of a trivalent or higher carboxylic acid monomer component include a polycarboxylic acid, such as trimellitic acid, pyromellitic acid and benzophenone tetracarboxylic acid, or an anhydride thereof.

Further, examples of other monomers include polyhydric alcohols, such as oxyalkylene ether of a novolak-type phenol resin.

As the polyester resin A according to the present invention, those described above can be used singly or in combinations of a plurality of kinds in order to improve pigment dispersibility or to ensure charge stability.

Further, in the binder resin, the content ratio (A/B) of the polyester resin A and the styrene resin B is 85/15 or more and 98/2 or less, based on mass.

If the content ratio (A/B) of the polyester resin A and the styrene resin B is in the above-described range, a hot offset suppressing effect can be obtained while maintaining the low-temperature fixability of the toner. More preferably, this content ratio is 87/13 or more and 97/3 or less.

If the content ratio (A/B) of the polyester resin A and the styrene resin B is in the above-described range, wax bleeding improves and hot offset resistance and low-temperature fixability are both achieved.

Further, the present invention is characterized in that the weight average molecular weight Mw based on GPC of the THF soluble component of the styrene resin B is 2,000 or more and 5,000 or less.

If the weight average molecular weight Mw of the styrene resin B is in the above-described range, good hot offset resistance can be obtained while maintaining low-temperature fixability and durable stability. Further, the wax is well dispersed and the occurrence of white steaks can be suppressed. The weight average molecular weight Mw may be 2,400 or more and 4,200 or less.

As the styrene resin B used in the toner according to the present invention, known resins may be used.

Examples include homopolymers of styrene derivatives, such as polystyrene and polyvinyl toluene; styrene/propylene copolymers; styrene/vinyl toluene copolymers; styrene/vinyl naphthalene copolymers; styrene/acrylic acid copolymers, such as styrene/methyl acrylate copolymers, styrene/ethyl acrylate copolymers, styrene/butyl acrylate copolymers, styrene/octyl acrylate copolymers and styrene/dimethylaminoethyl acrylate copolymers; styrene/methacrylic acid copolymers, such as styrene/methyl methacrylate copolymers, styrene/ethyl methacrylate copolymers, styrene/butyl methacrylate copolymers, styrene/octyl methacrylate copolymers and styrene/dimethylaminoethyl methacrylate copolymers; styrene/vinyl methyl ether copolymers; styrene/vinyl ethyl ether copolymers; styrene/vinyl methyl ketone copolymers; styrene/butadiene copolymers; styrene/isoprene copolymers; and styrene copolymers such as styrene/maleic acid copolymers and styrene/maleate copolymers. These can be used singly or in combinations of a plurality thereof.

From the perspective of achieving both low-temperature fixability and blocking resistance, the above-described styrene resin B may have a softening point Tm of 70° C. or more and 120° C. or less and a glass transition temperature Tg of 45° C. or more and 80° C. or less.

Further, the toner according to the present invention can contain as a binder resin a polymer C having a structure in which a vinyl resin component and a hydrocarbon compound are linked.

As the above-described polymer C, preferred are a polymer in which a polyolefin is linked to a vinyl resin component, or a polymer having a vinyl resin component in which a vinyl monomer is linked to a polyolefin.

The above-described polymer C is thought to increase the affinity of the wax with the polyester resin A. Consequently, the polymer C can suppress excessive bleeding of the wax onto the toner surface and contributes to an improvement in the durability of the developer. Further, although the mechanism is not clear, when the polymer C is present, the bleeding speed during fixing of the wax dispersed in the styrene resin increases and there is also an effect regarding the hot offset resistance.

The content ratio of the polymer C may be, based on 100 parts by mass of the binder resin, 2 parts by mass or more and 10 parts by mass or less, and more preferably 3 parts by mass or more and 8 parts by mass or less.

If the content ratio of the polymer C is in the above-described range, the high glossiness and durable stability of the printed image can be further improved while maintaining a hot offset resistance effect and fixing wraparound resistance.

The polyolefin in the polymer C is not especially limited and various polyolefins can be used, as long as the polyolefin is a polymer or copolymer of an unsaturated hydrocarbon monomer having one double bond. It is especially preferred to use a polyethylene or polypropylene type polymer.

Examples of the vinyl monomer used for the vinyl resin component in polymer C include the following.

Styrene monomers, such as styrenes and derivatives thereof like styrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene and p-n-dodecylstyrene.

Amino-group-containing α-methylene aliphatic monocarboxylic acid esters such as dimethylaminoethyl methacrylate and diethylaminoethyl methacrylate; and vinyl monomers including a N atom of an acrylic acid or methacrylic acid derivative, such as acrylonitrile, methacrylonitrile and acrylamide.

Unsaturated dibasic acids, such as maleic acid, citraconic acid, itaconic acid, alkenyl succinic acid, fumaric acid and mesaconic acid; unsaturated dibasic acid anhydrides, such as maleic anhydride, citraconic anhydride, itaconic anhydride and alkenyl succinic anhydride; half esters of unsaturated dibasic acids, such as methyl maleate half ester, ethyl maleate half ester, butyl maleate half ester, methyl citraconate half ester, ethyl citraconate half ester, butyl citraconate half ester, methyl itaconate half ester, methyl alkenylsuccinate half ester, methyl fumarate half ester and methyl mesaconate half ester; unsaturated dibasic acid esters, such as dimethyl maleate and dimethyl fumarate; α,β-unsaturated acids, such as acrylic acid, methacrylic acid, crotonic acid and cinnamic acid; anhydrides of α,β-unsaturated acids, such as crotonic anhydride and cinnamic anhydride; anhydrides of the above-mentioned α,β-unsaturated acids and lower aliphatic acids; and vinyl monomers including a carboxyl group, such as alkenylmalonic acid, alkenylglutaric acid and alkenyladipic acid, acid anhydrides thereof and monoesters thereof.

Acrylate esters or methacrylate esters, such as 2-hydroxyethyl acrylate, 2-hydroxyethyl methacrylate and 2-hydroxypropyl methacrylate; and vinyl monomers including a hydroxyl group, such as 4-(1-hydroxy-1-methylbutyl) styrene and 4-(1-hydroxy-1-methylhexyl) styrene.

Ester units formed from an acrylic ester and the like, such as an acrylic ester like methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate and phenyl acrylate.

Ester units formed from a methacrylic ester of an α-methylene aliphatic monocarboxylate and the like, such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate and diethylaminoethyl methacrylate.

The polymer C used in the present invention having a structure formed by reacting a vinyl resin component and a hydrocarbon compound can be obtained by a known method, such as reacting the above-described vinyl monomers together and reacting the monomer of one of the polymers with the other polymer.

As the constituent units of the vinyl resin component, a styrene unit, an ester unit, as well as an acrylonitrile or a methacrylonitrile may be included.

As the binder resin used in the toner according to the present invention, to improve pigment dispersibility, or to improve the charge stability or blocking resistance of the toner, in addition to the above-described resins A and B and the polymer C, the following polymers may also be added in an amount that does not hinder the effects of the present invention.

Examples that may be used include a homopolymer of styrene and substituted styrenes, such as polystyrene, poly-p-chlorostyrene and polyvinyl toluene; a styrene copolymer, such as a styrene/p-chlorostyrene copolymer, a styrene/vinyl toluene copolymer, a styrene/vinyl naphthalene copolymer, a styrene/acrylate copolymer, a styrene/methacrylate copolymer, a styrene/α-chloromethyl methacrylate copolymer, a styrene/acrylonitrile copolymer, a styrene/vinyl methyl ether copolymer, a styrene/vinyl ethyl ether copolymer, a styrene/vinyl methyl ketone copolymer and a styrene/acrylonitrile/indene copolymer; as well as polyvinyl chloride, a phenol resin, a natural modified phenol resin, a natural-resin modified maleic acid resin, an acrylic resin, a methacrylic resin, polyvinyl acetate, a silicone resin, a polyester resin, polyurethane, a polyamide resin, a furan resin, an epoxy resin, a xylene resin, polyvinyl butyral, a terpene resin, a coumarone-indene resin and a petroleum resin.

Examples of the wax used in the toner according to the present invention include the following: hydrocarbon waxes, such as low molecular weight polyethylene, low molecular weight polypropylene, an alkylene copolymer, microcrystalline wax, paraffin wax and a Fischer-Tropsch wax; oxides of a hydrocarbon wax or a block copolymer thereof such as oxidized polyethylene wax; waxes mainly formed from a fatty acid ester such as carnauba wax; and waxes obtained by partially or wholly deoxidizing a fatty acid ester such as deoxidized carnauba wax. Other examples include the following: saturated straight-chain fatty acids, such as palmitic acid, stearic acid and montanic acid; unsaturated fatty acids such as brassidic acid, eleostearic acid and parinaric acid; saturated alcohols such as stearyl alcohol, aralkyl alcohol, behenyl alcohol, carnaubyl alcohol, ceryl alcohol and melissyl alcohol; polyhydric alcohols such as sorbitol; esters of a fatty acid, such as palmitic acid, stearic acid, behenic acid and montanic acid and an alcohol such as stearyl alcohol, aralkyl alcohol, behenyl alcohol, carnaubyl alcohol, ceryl alcohol and melissyl alcohol; fatty acid amides such as linoleic acid amide, oleic acid amide and lauric acid amide; saturated fatty acid bisamides such as methylenebisstearic acid amide, ethylenebiscapric acid amide, ethylenebislauric acid amide and hexamethylenebisstearic acid amide; unsaturated fatty acid amides such as ethylenebisoleic acid amide, hexamethylenebisoleic acid amide, N,N′-dioleyl adipic acid amide and N,N′-dioleyl sebacic acid amide; aromatic bisamides such as m-xylenebisstearic acid amide and N,N′-distearyl isophthalic acid amide; aliphatic metal salts such as calcium stearate, calcium laurate, zinc stearate and magnesium stearate (generally known as metal soaps); waxes obtained by grafting vinyl monomers such as styrene and acrylic acid to aliphatic hydrocarbon waxes; partially esterified products of fatty acid and polyhydric alcohol, such as behenic acid monoglyceride; and hydroxyl group-containing methyl ester compounds obtained by hydrogenating vegetable oils and fats.

Among such waxes, from the perspective of improving low-temperature fixability and hot offset resistance, a hydrocarbon wax such as paraffin wax or a Fischer-Tropsch wax, or a fatty acid ester wax such as carnauba wax, is preferred. In the present invention, more preferred is a hydrocarbon wax, which has good compatibility with the styrene resin B and which more easily exhibits hot offset resistance during fixing when performing high-speed printing.

In the present invention, 1 part by mass or more and 20 parts by mass or less of the wax may be used based on 100 parts by mass of the binder resin. Further, if the wax content is W (parts by mass) and the total content of the styrene resin B and the polymer C is T (parts by mass), it is preferred that W and T satisfy the relationship 0.4≦T/W≦10.0. If T/W is within the above range, the compatibilization/dispersion of the wax in the styrene resin is appropriate, good low-temperature fixability is exhibited and a good hot offset resistance can be obtained.

Further, the peak temperature of the maximum endothermic peak of the wax on the endothermic curve when the temperature is increasing as measured with a differential scanning calorimetry may be 45° C. or more and 140° C. or less. It is preferred that the peak temperature of the maximum endothermic peak of the wax is in this range, since storability and hot offset resistance of the toner can both be achieved.

Examples of colorants that can be contained in the toner include the following.

Examples of black colorants include carbon black; and colorants adjusted to a black color using a yellow colorant, a magenta colorant and a cyan colorant. Although a pigment may be used alone as the colorant, from the perspective of the image quality of a full-color image, the color definition can be improved by combining a dye and a pigment.

Examples of magenta toner pigments include the following: C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269 and 282; C.I. Pigment Violet 19; and C.I. Vat Red 1, 2, 10, 13, 15, 23, 29 and 35.

Examples of magenta toner dyes include the following: oil-based dyes such as: C.I. Solvent Red 1, 3, 8, 23, 24, 25, 27, 30, 49, 81, 82, 83, 84, 100, 109 and 121; C.I. Disperse Red 9; C.I. Solvent Violet 8, 13, 14, 21 and 27; and C.I. Disperse Violet 1 and basic dyes such as C.I. Basic Red 1, 2, 9, 12, 13, 14, 15, 17, 18, 22, 23, 24, 27, 29, 32, 34, 35, 36, 37, 38, 39 and 40; and C.I. Basic Violet 1, 3, 7, 10, 14, 15, 21, 25, 26, 27 and 28.

Examples of cyan toner pigments include the following: C.I. Pigment Blue 2, 3, 15:2, 15:3, 15:4, 16 and 17; C.I. Vat Blue 6; C.I. Acid Blue 45 and copper phthalocyanine pigment substituted with 1 to 5 phthalimidomethyl groups on the phthalocyanine skeleton.

Examples of cyan toner dyes include C.I. Solvent Blue 70.

Examples of yellow toner pigments include the following: C.I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181 and 185; and C.I. Vat Yellow 1, 3 and 20.

Examples of yellow toner dyes include C.I. Solvent Yellow 162.

The amount of the colorant used may be 0.1 parts by mass or more and 30 parts by mass or less based on 100 parts by mass of the binder resin.

The toner can optionally contain a charge control agent. A known charge control agent can be used as the charge control agent to be contained in the toner. However, especially preferred is a metal compound of an aromatic carboxylic acid that is colorless, affords fast charging speed of the toner and allows a constant charge quantity to be stably maintained.

Examples of negative-type charge control agents include salicylic acid metal compounds, naphthoic acid metal compounds, dicarboxylic acid metal compounds, polymer compounds having sulfonic acid or a carboxylic acid in a side chain, polymer compounds having a sulfonic acid salt or a sulfonic acid esterified product in a side chain, polymer compounds having a carboxylic acid salt or a carboxylic acid esterified product in a side chain, boron compounds, urea compounds, silicon compounds and calixarene. Examples of positive-type charge control agents include quaternary ammonium salts, polymer compounds having such a quaternary ammonium salt in a side chain, guanidine compounds and imidazole compounds. The charge control agent may be added to the toner particles in the form of an internal additive or an external additive. The amount of the charge control agent added may be 0.2 parts by mass or more and 10 parts or less by mass based on 100 parts by mass of the binder resin.

An external additive may be added to the toner in order to improve fluidity and durable stability. Preferred external additives include inorganic fine powder such as silica, titanium oxide and aluminum oxide. The inorganic fine powder may be subjected to a hydrophobic treatment by a hydrophobizing agent such as a silane compound, silicone oil or a mixture thereof.

As an external additive to improve fluidity, an inorganic fine powder having a specific surface area of 50 m²/g or more and 400 m²/g or less is preferred. As an external additive to improve durable stability, an inorganic fine powder having a specific surface area of 10 m²/g or more and 50 m²/g or less is preferred. To achieve an improvement in both fluidity and durable stability, inorganic fine powders having a specific surface area in the above ranges may be used together.

The external additive may be used in an amount of 0.1 parts by mass or more and 10.0 parts by mass or less based on 100 parts by mass of the toner particles. The toner particles and the external additive may be mixed using a known mixer, such as a Henschel mixer.

Although the toner according to the present invention can be used as a one-component developer, in order to further improve dot reproducibility, the toner may be used as a two-component developer mixed with a magnetic carrier since this enables an image that is stable over a long period to be obtained.

Generally known magnetic carriers may be used as the magnetic carrier, for example magnetic materials such as iron powder whose surface has been oxidized, or non-oxidized iron powder, metal particles of lithium, calcium, magnesium, nickel, copper, zinc, cobalt, manganese, chromium and rare earths, alloy particles thereof, oxide particles and ferrite; or a resin carrier in which a magnetic material is dispersed (so-called resin carrier) that contains a magnetic material and a binder resin holding the magnetic material in the dispersed state.

If the toner according to the present invention is used as a two-component developer mixed with a magnetic carrier, good results can generally be obtained by setting the carrier mixing ratio during that operation to, based on the toner concentration in the two-component developer, 2 mass % or more and 15 mass % or less and preferably 4 mass % or more and 13 mass % or less.

Examples of methods for producing the toner particles include: a pulverization method, in which a binder resin and a wax are melt-kneaded, the melt-kneaded product is cooled and, thereafter, pulverization and classification are performed; a suspension granulation method, in which a solution prepared by dissolving or dispersing a binder resin and a wax into a solvent is introduced into an aqueous medium to carry out suspension granulation and the solvent is removed so as to obtain toner particles; a suspension polymerization method, in which a monomer composition prepared by uniformly dissolving or dispersing a wax or the like into a monomer is dispersed into a continuous layer (for example, an aqueous phase) containing a dispersion stabilizer and a polymerization reaction is effected so as to form toner particles; a dispersion polymerization method, in which toner particles are directly formed by using a monomer, which although is soluble, becomes insoluble when forming a polymer and an aqueous organic solvent, which although is soluble in the monomer to directly form toner particles using the aqueous organic solvent, is unable to dissolve the resulting polymer; an emulsion polymerization method, in which polymerization is directly performed in the presence of a water-soluble polar polymerization initiator to form toner particles; and an emulsion aggregation method, in which toner particles are obtained through a step of forming fine particle aggregates by aggregating at least polymer fine particles and a wax and an aging step of causing the fine particles in the fine particle aggregates to fuse together.

A toner production procedure that is based on a pulverization method will now be described.

In a raw material mixing step, as the materials that form the toner particles, predetermined amounts of, for example, the binder resin, the wax and, optionally, other components such as a colorant and a charge control agent, are weighed, blended and mixed. Examples of mixing apparatuses include double-cone mixers, V-type mixers, drum-type mixers, supermixers, Henschel mixers, Nauta mixers and a Mechano Hybrid mixer (manufactured by Nippon Coke & Engineering Co., Ltd.).

Next, the mixed material is melt-kneaded to disperse the wax and the like in the binder resin. In the melt kneading step, a batch kneader such as pressure kneader or a Banbury mixer, or a continuous-type kneader can be used. Single- or twin-screw extruders are mainly used due to their superiority in enabling continuous production. Examples thereof include a KTK-type twin-screw extruder (manufactured by Kobe Steel, Ltd.), a TEM-type twin-screw extruder (manufactured by Toshiba Machine Co., Ltd.), a PCM kneader (manufactured by Ikegai Corp.), a twin-screw extruder (by KCK Co., Ltd.), a Ko-kneader (manufactured by Buss AG) and a Kneadex (by Nippon Coke & Engineering Co., Ltd.). In addition, the resin composition obtained by melt-kneading may be rolled using twin rolls or the like and cooled with water or the like in a cooling step.

The cooled product of the resin composition is pulverized to a desired particle size in a pulverization step. In the pulverization step, coarse pulverization is performed using, for example, a pulverizer such as a crusher, a hammer mill or a feather mill. This is followed by fine pulverization using, for example, a Kryptron System (manufactured by Kawasaki Heavy Industries, Ltd.), a Super Rotor (manufactured by Nisshin Engineering Inc.), a Turbo Mill (manufactured by Freund-Turbo Corporation), or an air-jet pulverizer.

Thereafter, the pulverized product is optionally classified using a classifier and a screen classifier, such as an Elbow-Jet (manufactured by Nittetsu Mining Co., Ltd.) that employs inertial classification, a Turboplex (manufactured by Hosokawa Micron Corporation) that employs centrifugal classification, a TSP separator (manufactured by Hosokawa Micron Corporation) and a Faculty (manufactured by Hosokawa Micron Corporation), to obtain a classified product (toner particles). Then, the obtained classified product is subjected to the below-described surface treatment by hot-air. The order of the classification and the surface treatment may be reversed. Further, before the surface treatment, the inorganic fine powder such as silica may also be subjected to an external additive treatment. Examples of the method for subjecting the external additive to an external additive treatment include blending predetermined amounts of classified toner and various known external additives and then stirring and mixing the mixture using a high-speed stirrer that imparts a shearing force on the powder, such as a Henschel mixer or a supermixer as external additive equipment.

As described above, the toner according to the present invention is subjected to a surface treatment by hot-air. In the present invention, the “surface treatment by hot-air” is a treatment that makes surfaces of toner particles smooth and the “hot-air” is an airflow capable of imparting a sufficient amount of heat to soften the surfaces of toner particles.

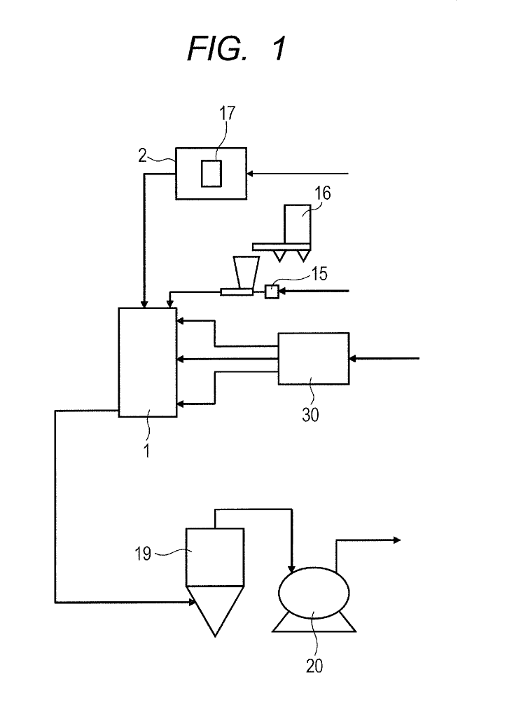

The surface treatment by hot-air can be carried out using, for example the surface treatment apparatus illustrated in FIGS. 1 to 4. However, the hot-air surface treatment method is not limited to that device.

FIG. 1 illustrates a flow in the toner surface heat-treatment apparatus according to the present invention. A surface heat-treatment apparatus main body 1 is provided on an upstream side with a hot-air supply unit 2, a (not illustrated) raw-material supply unit and a (not illustrated) cold-air supply unit, and on a downstream side with a (not illustrated) recovery unit and a suction discharge unit (blower) 20. The hot-air supply unit 2 supplies hot air by heating outside air with an internal heater 17. Since the (not illustrated) raw-material supply unit volumetrically feeds raw materials from the upstream side, a compressed-gas supply unit (ejector) 15 is included downstream from a raw-material volumetric feeder 16, and the raw materials are transported to the surface heat-treatment apparatus main body 1 by a compressed gas. Further, to cool the heat-treated toner, the surface heat-treatment apparatus main body 1 includes a (not illustrated) cold-air supply unit that supplies cold air fed from a cold-air supply machine (30). The heat-treated toner is sucked up by the suction discharge unit (blower) 20 and recovered.

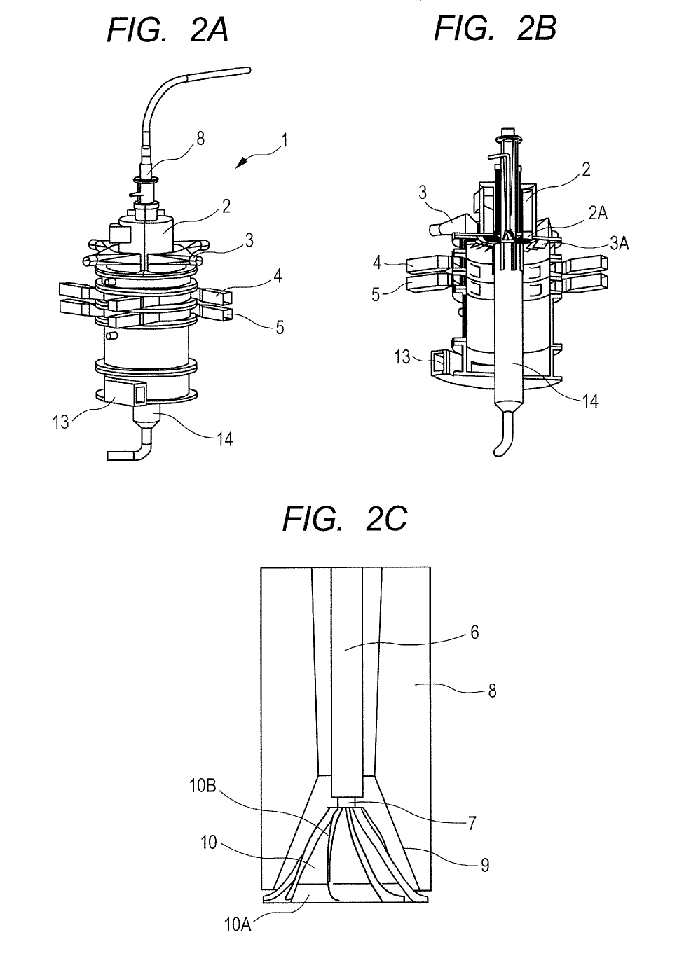

Next, the toner surface heat-treatment apparatus main body according to the present invention will be described. FIGS. 2A to 2C illustrate an example of the toner surface heat-treatment apparatus according to the present invention. The apparatus circumferential has a maximum diameter of 500 mm, and the height from a lower portion apparatus bottom face to the top plate (powder introduction pipe outlet) is set at about 1,200 mm.

FIG. 2A illustrates the appearance of the surface heat-treatment apparatus. FIG. 2B illustrates the internal configuration of the surface heat-treatment apparatus. FIG. 2C is an expanded view of the outlet portion of a raw-material supply unit 8. The scope of the following apparatus configuration and operating conditions is based on the assumption with the above-described apparatus scale.

The raw-material supply unit 8 is provided with a radially extending first nozzle 9 and a second nozzle 10 that is arranged on an inward side of the first nozzle. The raw-material toner particles supplied to the raw-material supply unit 8 are accelerated by a compressed gas supplied from the compressed-gas supply unit 15. The raw-material toner particles then pass through a space defined by the first nozzle 9, which are provided at the outlet portion of the raw-material supply unit 8, and the second nozzle 10, and the raw-material toner particles are injected in a ring shape toward the outer side in the circumferential direction of the toner treatment space in the apparatus. Further, a first tubular member 6 and a second tubular member 7 are provided in the raw-material supply unit 8. The compressed gas is supplied into each of the tubular members. The compressed gas that has passed through the first tubular member 6 passes through the space defined by the first nozzle 9 and the second nozzle 10. The second tubular member 7 passes through the second nozzle 10, and on an inner side of the second nozzle 10, the compressed gas is injected from the outlet portion of the second tubular member 7 toward the inner surface of the second nozzle 10. A plurality of ribs 10B is provided on the outer peripheral surface of the second nozzle 10. The ribs 10B are curved in the direction that the hot air supplied from the below-described hot-air supply unit 2 flows. Further, the second nozzle 10 extends in a tapered shape toward the outlet portion direction from the connecting portion with the second tubular member 7. At the end portion in the outlet portion direction, the taper angle again changes, and a return portion 10A extending radially is provided.

In the toner surface heat-treatment apparatus according to the present invention, the hot-air supply unit 2 is circumferentially provided at a position adjacent to or horizontally spaced from the outer peripheral surface of the raw-material supply unit 8. Furthermore, a first cold-air supply unit 3, a second cold-air supply unit 4 and a third cold-air supply unit 5 are provided outside and downstream of the hot-air supply unit 2 in order to cool heat-treated toner and prevent coalescence or fusion of the toner particles due to an increase in the internal temperature of the apparatus. The hot-air supply unit 2 may be circumferentially provided at a position horizontally spaced from the outer peripheral surface of the raw-material supply unit 8. The reason for this is to prevent the melting and adhesion of the toner particles ejected from the outlet portion due to the fact that the outlet portions of the first and second nozzles are heated by hot air supplied.

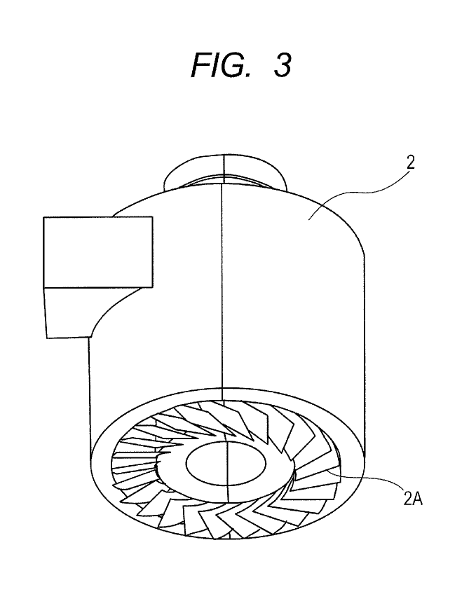

FIG. 3 is a partial cross-sectional perspective view illustrating an example of the hot-air supply unit 2 and an airflow adjustment unit 2A according to the present invention. As illustrated in FIG. 3, at the outlet portion of the hot-air supply unit 2, the airflow adjustment unit 2A is provided to supply hot air into the apparatus in such a manner that the hot air is obliquely fed and swirled. The airflow adjustment unit 2A is configured from a plurality of plate-shaped louvers. The hot air supplied from the cylindrical hot-air supply unit 2 to the toner treatment space flows in an oblique manner due to the louvers in the airflow adjustment unit 2A and swirls around in the toner treatment space. The toner particles fed from the raw-material supply unit 8 are swept up by the flow of hot air and swirled around.

The number and angle of the louver vanes in the airflow adjustment unit 2A may be arbitrarily adjusted based on the type of raw material and the amount of treatment. The tilt angle of the louver vanes in the airflow adjustment unit 2A may be set so that the angle of the main surface of the vanes to the vertical direction is 20° to 70°, and more preferably 30° to 60°. If the tilt angle of the vanes is within the above range, a reduction in air velocity in the vertical direction can be suppressed while maintaining an appropriate level of swirling of the hot air in the apparatus. Consequently, even if the amount of treatment is increased, the toner particles are prevented from coalescing. In addition, the accumulation of heat in the upper portion of the apparatus is prevented, so that efficiency is good also in terms of production energy.

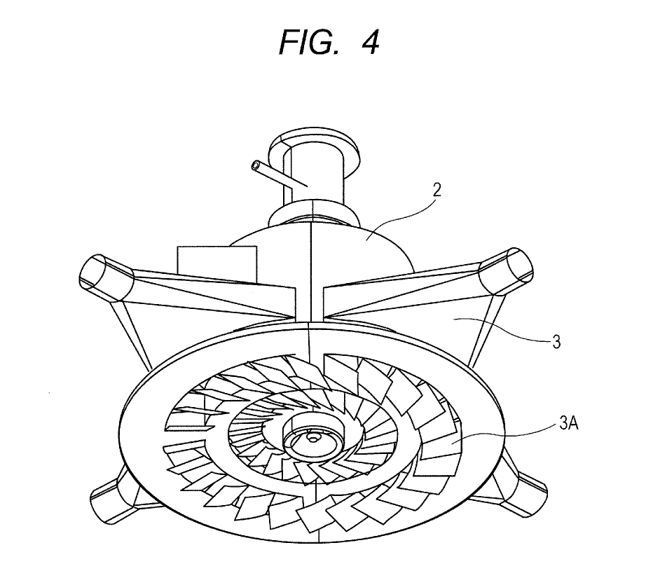

The surface heat-treatment apparatus according to the present invention may have a cold-air supply unit. FIG. 4 is a partial cross-sectional perspective view illustrating an example of the first cold-air supply unit 3 and an airflow adjustment unit 3A. As illustrated in FIG. 4, the airflow adjustment unit 3A, in which a plurality of louvers is obliquely arranged at fixed intervals in such a manner that cold air is swirled in the toner treatment space of the apparatus, is provided at the outlet portion of the first cold-air supply unit 3. The louvers in the airflow adjustment unit 3A are arranged so that the tilt of the louvers is adjusted in such a manner that the cold air is swirled in a direction substantially the same as the swirl direction of the hot air from the hot-air supply unit 2 described above (a direction that maintains the swirl of the raw-material toner in the toner treatment space). Such an arrangement further strengthens the swirling force of the hot air and suppresses an increase in the temperature of the toner treatment space, thus preventing the fusion of the toner particles to an outer peripheral portion in the apparatus and the coalescence of the toner particles.

The number and angle of the louver vanes in the airflow adjustment unit 3A of the first cold-air supply unit 3 may also be arbitrarily adjusted based on the type of raw material and the amount of treatment. The tilt angle of the louver vanes in the first cold-air supply unit 3 may be set so that the angle of the main surface of the vanes to the vertical direction is 20° to 70°, and more preferably 30° to 60°. If the tilt angle of the vanes is within the above range, the flow of the hot air and the toner particles in the toner treatment space of the apparatus is not inhibited. Furthermore, the accumulation of heat in the upper portion of the apparatus is prevented.

Further, in the present invention, one or more cold-air supply units may be arranged below the hot-air supply unit in addition to the above-described cold-air supply unit. In this case, when cold air is supplied to the inside of the apparatus, the cold air may be introduced from several positions spaced apart in the vertical direction of the apparatus. For example, in the apparatus illustrated in FIG. 2A, the stream of cold air from the first cold-air supply unit 3, the second cold-air supply unit 4 and the third cold-air supply unit 5 is divided into four streams that are separately introduced into the toner treatment space. This is done to make it easier to uniformly control the flow of air in the apparatus. The flow rates of the cold air in the four separate introduction channels are independently controllable. The second and third cold-air supply units 4 and 5 may be provided below the first cold-air supply unit 3 in such a manner that the streams of the cold air are supplied horizontally and tangentially from outer peripheral portions of the apparatus.

A cylindrical pole 14 extending from the lowermost portion of the apparatus to the vicinity of the second nozzle 10 is provided in the axially central portion of the apparatus. The pole 14 outer circumference is configured with a cooling jacket to prevent fusing. Further, the pole 14 can also be configured so that cold air is introduced inside the pole 14 and discharged from an outer peripheral surface of the pole 14. The pole 14 includes an outlet portion configured to release the cold air in a direction substantially the same as the swirl direction of the hot air supplied from the hot-air supply unit 2 and the cold air supplied from the first cold-air supply unit 3, the second cold-air supply unit 4 and the third cold-air supply unit 5 (a direction that maintains the swirl of the raw-material toner in the toner treatment space). Examples of the shape of the outlet portion of the pole 14 include a slit shape, a louver shape, a perforated-plate shape and a mesh shape.

In addition, to prevent fusion of the toner particles, a cooling jacket is provided on the outer peripheral portion of the raw-material supply unit 8, the outer peripheral portion of the apparatus, the inner peripheral portion of the hot-air supply unit 2 and the outer peripheral portion of a recovery unit 13. The cooling jacket may be filled with cooling water or an antifreeze solution, such as ethylene glycol.

Cooling efficiency can be increased by integrally configuring the raw-material supply unit 8 and the first nozzle 9 and providing a cooling jacket around these parts. Further, in the raw-material supply path from upstream of the raw-material supply unit 8 until the first nozzle 9, the diameter of the portion connecting to the first nozzle is designed to be smaller than the diameter of the upstream end of the raw-material supply unit 8. This configuration may have a so-called tapered shape. In such a case, the velocity of the supplied toner particles at the first nozzle 9 inlet is temporarily increased, which can further aid in dispersion of the toner particles.

The hot air supplied into the apparatus may have a temperature C (° C.) at the outlet portion of the hot-air supply unit 2 of 100≦C≦450. If the temperature at the outlet portion of the hot-air supply unit 2 is within the above range, the toner particles can be uniformly subjected to the surface heat treatment, while preventing fusion and coalescence of the toner particles caused by excessive heating. More preferably, the temperature C is 100≦C≦300.

A temperature E (° C.) in the first cold-air supply unit 3, the second cold-air supply unit 4 and the third cold-air supply unit 5 may be −20≦E≦40. If the temperature in the cold-air supply units is within the above range, the toner particles can be appropriately cooled, so that fusion and coalescence of the toner particles can be prevented without hindering the uniform hot-air treatment of the toner particles.

The cold air supplied into the apparatus may have an absolute moisture content in the first cold-air supply unit 3, the second cold-air supply unit 4 and the third cold-air supply unit 5 of 5 g/m³ or less. If the absolute moisture content is within this range, the wax in the toner particles can be more easily moved in the surface direction by the hot-air surface treatment without causing the dispersion state to deteriorate. More preferred is an absolute moisture content of 3 g/m³ or less.

The cooled toner particles are passed through the recovery unit 13 that has a toner discharge outlet, and then recovered. The suction discharge unit (blower) 20 is provided downstream of the recovery unit 13, and the toner particles are sucked up and conveyed by the suction discharge unit (blower) 20. The recovery unit 13 is provided at the lowermost portion of the apparatus horizontal to the outer peripheral portion of the apparatus. The discharge outlet connection faces in the direction that maintains the flow caused by swirling from the upstream portion of the apparatus to the discharge outlet.

In the surface heat-treatment apparatus, the relationship between the total flow rate QIN of the compressed gas, the hot air and the cold air, supplied into the apparatus and the flow rate QOUT that is sucked out by the suction discharge unit (blower) 20 may be adjusted so as to satisfy the relationship QIN≦QOUT. When QIN≦QOUT, the injected toner particles are easily discharged from the apparatus because of the negative pressure in the apparatus, thereby preventing the toner particles from being excessively heated. Consequently, an increase in the number of coalesced toner particles and fusion of the toner particles in the apparatus can be prevented.

The average circularity of the toner particles after the hot-air surface treatment may be, from the perspectives of transfer efficiency and developing properties, 0.950 or more and 0.980 or less. More preferred is 0.955 or more and 0.975 or less. The average circularity of the toner particles can be adjusted by changing the hot-air treatment temperature. Even for a toner to which an external additive has been added, it is still preferred that the average circularity is 0.950 or more and 0.980 or less.

Optionally, the toner particles may be subjected to further surface treatment and a spherizing treatment using, for example, a Hybridization System manufactured by Nara Machinery Co., Ltd., or a Mechanofusion System manufactured by Hosokawa Micron Corporation. In such a case, a sieving machine, e.g., a wind power sieve Hi-Bolter (manufactured by Shin Tokyo Kikai K.K.), may also optionally be used.

In addition, in the toner particles subjected to the hot-air surface treatment, the external additive may optionally be subjected to an external additive treatment. Examples of the method for subjecting the external additive to an external additive treatment include blending predetermined amounts of classified toner and various known external additives and then stirring and mixing the mixture using a high-speed stirrer that imparts a shearing force on the powder, such as a Henschel mixer or a supermixer as external additive equipment.

The methods for measuring the physical properties of the above-described toner and raw materials will now be described.

<Method for Measuring Toner Average Circularity>

The average circularity of the toner is measured with a flow-type particle image analyzer “FPIA-3000” (manufactured by Sysmex Corporation) under the measurement and analysis conditions as at the time of calibration.

The measurement principle of the flow-type particle image analyzer “FPIA-3000” (manufactured by Sysmex Corporation) involves capturing static images of flowing particles, and analyzing the images. A sample added to a sample chamber is transferred to a flat-sheath flow cell by a sample suction syringe. The sample fed into the flat-sheath flow cell forms a flat flow due to being sandwiched between sheath liquids. The sample passing through the flat-sheath flow cell is irradiated with stroboscopic light at intervals of 1/60th of a second, which enables images of the flowing particles to be captured as static images. The images of the particles are captured in an in-focus state, since the flow is flat. The particle image is captured by a CCD camera, and the captured image is subjected to image processing at an image processing resolution of 512×512 pixels (0.37×0.37 μm per pixel). The outline of each particle image is extracted, and a projected area S, a perimeter L and the like of each particle image are measured.

The circle-equivalent diameter and circularity are determined using the area S and perimeter L. The circle-equivalent diameter is defined as the diameter of a circle having the same area as that of the projected area of a particle image. The circularity C is defined as the value obtained by dividing the perimeter of the circle determined from the circle-equivalent diameter by the perimeter of a particle projection image. The circularity is calculated based on the following equation.

Circularity C=2×(π×S)^{1/2}/L

The circularity of a perfectly round particle image is 1.000. The larger the degree of irregularity of the periphery of a particle image, the smaller the value of circularity of the particle in the image. After calculation of the circularity of each particle, an average circularity value is obtained by dividing a circularity range of 0.200 to 1.000 into 800 sections, and calculating the arithmetic mean value of the obtained circularities.

The specific measurement method is as follows. First, about 20 ml of deionized water from which solid impurities and the like have been removed beforehand is charged into a container made of glass. Then, about 0.2 ml of a diluted solution prepared by diluting “Contaminon N” (a 10 mass % aqueous solution of a neutral detergent for washing precision measuring instruments having a pH of 7, containing a nonionic surfactant, an anionic surfactant and an organic builder, manufactured by Wako Pure Chemical Industries, Ltd.) with about three times its mass of deionized water, is added as a dispersant to the container. Further, about 0.02 g of a measurement sample is added to the container, and the mixture is subjected to a dispersion treatment using an ultrasonic dispersing unit for 2 minutes, to obtain a dispersion for measurement. The dispersion is appropriately cooled to a temperature of 10° C. or more and 40° C. or less. A desktop ultrasonic cleaning and dispersing unit having an oscillation frequency of 50 kHz and an electrical output of 150 W (such as a “VS-150” (manufactured by Velvo-Clear)) is used as the ultrasonic dispersing unit. A predetermined amount of deionized water is charged into a water tank, and about 2 ml of Contaminon N is added to the water tank.

The flow-type particle image analyzer equipped with a standard objective lens (10× magnification) was used in the measurement, and a particle sheath “PSE-900A” (manufactured by Sysmex Corporation) was used as the sheath liquid. The dispersion prepared according to the above procedure is introduced into the flow-type particle image analyzer, and the particle size of 3,000 toner particles is measured according to a total count mode in an HPF measurement mode. By setting the binarization threshold during particle analysis to 85% and specifying the analyzed particle size, the percentage (%) and average circularity of particles in that range can be calculated. The average circularity of the toner was determined for a circle-equivalent diameter of 1.98 μm or more and 39.96 μm or less.

Prior to the start of measurement, automatic focus adjustment is performed using standard latex particles (obtained by diluting, for example, “RESEARCH AND TEST PARTICLES Latex Microsphere Suspensions 5200A” manufactured by Duke Scientific with deionized water). Thereafter, focus adjustment may be performed every 2 hours from measurement start.

In the Examples of the present application, a flow-type particle image analyzer calibrated by Sysmex Corporation, and issued with a calibration certificate by Sysmex Corporation, was used. Measurement was performed under the same measurement and analysis conditions as those when the calibration certificate was issued, except that analyzed particle size was limited to a circle-equivalent diameter of 1.98 μm or more and less than 39.69 μm.

<Method for Measuring the Peak Molecular Weight (Mp), Number Average Molecular Weight (Mn) and Weight Average Molecular Weight (Mw) of the Resin>

The peak molecular weight (Mp), the number average molecular weight (Mn) and the weight average molecular weight (Mw) are measured as follows by gel permeation chromatography (GPC).

First, a sample (resin) is dissolved in tetrahydrofuran (THF) over 24 hours at room temperature. The obtained solution is filtered using a solvent-resistant membrane filter “Maishori Disk” (manufactured by Tosoh Corporation) having a pore size of 0.2 μm, to obtain a sample solution. The sample solution is adjusted so that the concentration of the component that is soluble in the THF is about 0.8 mass %. The sample solution is measured under the following conditions.

Apparatus: HLC 8120 GPC (detector: RI) (manufactured by Tosoh Corporation)
Column: Series of seven columns, Shodex KF-801, 802, 803, 804, 805, 806 and 807 (manufactured by Showa Denko K.K.)

### Eluent: Tetrahydrofuran (THF)

Flow rate: 1.0 ml/min
Oven temperature: 40.0° C.
Amount of sample injection: 0.10 ml

To calculate the molecular weight of the sample, a molecular weight calibration curve is used that was obtained using a standard polystyrene resin (e.g., trade name: “TSK standard polystyrene F-850, F-450, F-288, F-128, F-80, F-40, F-20, F-10, F-4, F-2, F-1, A-5000, A-2500, A-1000 and A-500” manufactured by Tosoh Corporation).

<Method for Measuring the Softening Point (Tm) of the Resin>

The softening point (Tm) of the resin is measured using a constant-load extruding capillary rheometer “Flow characteristic evaluation apparatus Flow Tester CFT-500D” (manufactured by Shimadzu Corporation) based on the manual included with the apparatus. This apparatus can be used to obtain a flow curve representing the relationship between temperature and the amount of descent of piston by increasing the temperature of a measurement sample that fills a cylinder to melt the measurement sample while applying a constant load with a piston from above the measurement sample, and extruding the melted measurement sample from a die at the bottom of the cylinder.

In the present invention, the softening point (Tm) is the “½-method melting temperature” described in the manual included with the “flow characteristic evaluation apparatus Flow Tester CFT-500D.” The “½-method melting temperature” is calculated as follows. First, ½ the difference (notated as X) between the amount of descent Smax of the piston when the flow stops, and the amount of descent Smin of the piston when flow starts is determined (i.e., X=(Smax−Smin)/2). The temperature of the flow curve when the amount of descent of the piston is X on the flow curve is the ½-method melting temperature.

The measurement sample is used that has a cylindrical shape about 8 mm in diameter obtained by compression-molding about 1.0 g of resin under a 25° C. environment at about 10 MPa for about 60 seconds using a tablet molding compressor (e.g., NT-100H, manufactured by NPa SYSTEM Co., Ltd.).

The CFT-500D measurement conditions are as follows.

Test mode: Increasing temperature method
Starting temperature: 50° C.
End-point temperature: 200° C.
Measurement interval: 1.0° C.
Rate of temperature increase: 4.0° C./min
Piston sectional area: 1.000 cm²
Test load (piston load): 10.0 kgf (0.9807 MPa)
Preheating time: 300 seconds
Die hole diameter: 1.0 mm
Die length: 1.0 mm

<Measurement of the Maximum Endothermic Peak Temperature of the Wax>

The maximum endothermic peak temperature of wax is measured using the differential scanning calorimeter “Q1000” (manufactured by TA Instruments) according to ASTM D3418-82. The temperature of the detection unit in the apparatus is corrected using the melting points of indium and zinc, and the amount of heat is corrected using the heat of fusion of indium.

Specifically, about 10 mg of wax is accurately weighed out and placed on an aluminum pan. Measurement is performed at a rate of temperature increase of 10° C./min over a measurement temperature range of 30° C. to 200° C., using an empty aluminum pan as a reference. In the measurement, the temperature is increased to 200° C. once, then lowered to 30° C., and is increased again. The temperature indicating the maximum endothermic peak on the DSC curve in the range of 30° C. to 200° C. during this second temperature increase process is taken as the maximum endothermic peak temperature of the wax.

<Measurement of the BET Specific Surface Area of the Fine Inorganic Particles>

The BET specific surface area of the fine inorganic particles is measured according to JIS 28830 (2001). The specific measurement method is as follows.

As the measurement apparatus, an “automatic specific surface area/pore distribution measuring apparatus TriStar 3000” (manufactured by Shimadzu Corporation) is used. The setting of the measurement conditions and analysis of the measurement data are carried out using the dedicated software “TriStar 3000 Version 4.00” included with the apparatus. A vacuum pump, a nitrogen gas pipe and a helium gas pipe are also connected to the apparatus. Nitrogen gas is used as the adsorption gas. The value calculated by the BET multipoint method is taken as the BET specific surface area of the fine inorganic particles in the present invention.

The BET specific surface area is calculated as follows.

First, the fine inorganic particles are made to adsorb nitrogen gas, and the equilibrium pressure P (Pa) in a sample cell at that point and an amount of nitrogen adsorption Va (mol/g) of the fine inorganic particles are measured. Then, an adsorption isotherm is obtained in which the abscissa axis represents relative pressure Pr, which is a value obtained by dividing the equilibrium pressure P (Pa) in the sample cell by the saturated vapor pressure Po (Pa) of nitrogen, and the ordinate axis represents the amount of nitrogen adsorption Va (mol/g). Next, an amount of monomolecular layer adsorption Vm (mol/g) as the amount of adsorption needed for the formation of a monomolecular layer on the surface of the fine inorganic particles is determined using the following BET equation.

Pr/Va(1−Pr)=1/(Vm×C)+(C−1)×Pr/(Vm×C)

wherein the BET parameter denoted as C is a variable that varies depending on the type of measurement sample, the type of adsorption gas and the adsorption temperature.

The BET equation can be interpreted as a straight line having a slope of (C−1)/(Vm×C) and an intercept of 1/(Vm×C), in which the X-axis represents Pr and the Y-axis represents Pr/Va(1−Pr) (this straight line is referred to as a “BET plot”).

Slope of straight line=(C−1)/Vm×C)

Straight line intercept=1/(Vm×C)

If actual measurement values for Pr and actual measurement values for Pr/Va(1−Pr) are plotted on a graph, and a straight line is drawn by a least-squares method, the straight line slope and the intercept value can be calculated. Vm and C can be calculated by solving the above simultaneous equations for the slope and the intercept using the above values.

Further, a BET specific surface area S (m²/g) of the fine inorganic particles is calculated from the calculated Vm and the molecule-occupied sectional area (0.162 nm²) of nitrogen molecules, based on the following equation.

S=Vm×N×0.162×10⁻¹⁸

wherein N represents Avogadro's number (mol⁻¹).

Measurements using the apparatus are performed according to the “TriStar 3000 Instruction Manual V4.0” included with the apparatus. Specifically, measurements are performed according to the following procedure.

The tare weight of a dedicated sample cell made of glass (having a stem diameter of ⅜ inch and a volume of about 5 ml) that has been thoroughly washed and dried is precisely weighed. Then, about 0.1 g of the fine inorganic particles is loaded into the sample cell using a funnel.

The sample cell containing the fine inorganic particles is set in a “pretreatment apparatus Vacu-prep 061 (manufactured by Shimadzu Corporation)” to which a vacuum pump and a nitrogen gas pipe are connected. Vacuum degassing is continued at 23° C. for about 10 hours. The vacuum degassing is gradually performed while a valve is adjusted so that the fine inorganic particles are not sucked up by the vacuum pump. Pressure in the cell gradually drops as degassing proceeds, eventually reaching about 0.4 Pa (about 3 mTorr). Once vacuum degassing has finished, nitrogen gas is gradually injected to return the pressure in the sample cell to atmospheric pressure, and then the sample cell is removed from the pretreatment apparatus. The mass of the sample cell is precisely weighed, and the precise mass of the fine inorganic particles is calculated based on the difference between the tare weight and the mass. During the weighing, the sample cell is capped with a rubber stopper to prevent the fine inorganic particles in the sample cell from being contaminated with, for example, moisture in the air.

Next, a special “isothermal jacket” is attached to a stem portion of the sample cell containing the fine inorganic particles. A special filler rod is inserted into the sample cell, and the sample cell is set in an analysis port of the apparatus. The isothermal jacket is a tubular member whose inner surface is formed from a porous material and outer surface is formed from an impervious material, that is capable of suctioning up liquid nitrogen to a given level by capillarity.

Next, the free space of the sample cell including the connection fixtures is measured. The volume of the sample cell is measured using helium gas at 23° C. Then, after cooling the sample cell in liquid nitrogen, the volume of the sample cell is similarly measured using helium gas. The free space is calculated based on the difference between these volumes. The saturated vapor pressure Po (Pa) of nitrogen is measured automatically, separately, using a Po tube that is built into the apparatus.

Next, the interior of the sample cell is vacuum-degassed, and the sample cell is cooled in liquid nitrogen while vacuum degassing is continued. Subsequently, nitrogen gas is introduced into the sample cell in a stepwise manner so that nitrogen molecules are adsorbed onto the fine inorganic particles. At this stage, since the adsorption isotherm can be obtained by continually measuring the equilibrium pressure P (Pa), this adsorption isotherm is converted to a BET plot. The data is collected at a total of six relative pressure Pr points, namely, 0.05, 0.10, 0.15, 0.20, 0.25 and 0.30. A straight line is drawn for the obtained measurement data by a least-squares method, and Vm is calculated from the slope and intercept of the straight line. In addition, the BET specific surface area of the fine inorganic particles is calculated using the value for Vm.

<Method for Measuring the Toner Weight Average Particle Size (D4)>

The toner weight average particle size (D4) is measured using a precision granularity distribution measuring apparatus “Coulter Counter Multisizer 3” (registered trademark, manufactured by Beckman Coulter, Inc.) that is provided with a 100 μm aperture tube, which relies on a pore electrical resistance method. The setting of the measurement conditions and the analysis of the measurement data is performed using dedicated software “Beckman Coulter Multisizer 3 Version 3.51” (manufactured by Beckman Coulter, Inc.) included with the apparatus. Measurement is performed with the number of effective measurement channels set to 25,000. Using this software, the measurement data is analyzed and subjected to calculations.

An electrolytic aqueous solution prepared by dissolving special grade sodium chloride in deionized water to a concentration of about 1 mass %, for example, “ISOTON II” (manufactured by Beckman Coulter, Inc.) can be used in the measurement.

The settings in the dedicated software are as follows prior to measurement and analysis.

In the “screen to change the standard measurement method (SOM)” of the dedicated software, the total count number in the control mode is set to 50,000 particles, the number of measurements is set to 1, and a value obtained by using “standard particles 10.0 μm” (manufactured by Beckman Coulter, Inc.) is set as a Kd value. A threshold value and a noise level are automatically set by pressing the “threshold/noise level measurement” button. The current is set to 1,600 pA, gain is set to 2, electrolyte solution is set to ISOTON II, and a check box for “flush aperture tube after measurement” is checked.

In the “setting screen for conversion from pulse to particle size” of the dedicated software, a bin interval is set to a logarithmic particle size, the number of particle size bins is set to 256, and a particle size range is set to 2 μm or more and 60 μm or less.

The specific measurement method is as follows.

(1) About 200 ml of the electrolytic aqueous solution is charged into a 250-ml round-bottom glass beaker, which is designed for the Multisizer 3. The beaker is set in a sample stand, and the electrolytic aqueous solution in the beaker is stirred with a stirrer rod at 24 revolutions/sec in a counterclockwise direction. Then, dirt and bubbles in the aperture tube are removed by the “aperture flush” function of the analysis software.

(2) About 30 ml of the electrolytic aqueous solution is charged into a 100-ml flat-bottom glass beaker. Then, about 0.3 ml of a diluted solution prepared by diluting “Contaminon N” (a 10 mass % aqueous solution having a pH of 7 of a neutral detergent for washing precision measuring instruments, containing a nonionic surfactant, an anionic surfactant and an organic builder, manufactured by Wako Pure Chemical Industries, Ltd.) with three times its mass of deionized water, is added as a dispersant to the beaker.

(3) A predetermined amount of deionized water is charged into the water tank of an ultrasonic dispersing unit “Ultrasonic Dispersion System Tetra 150” (manufactured by Nikkaki Bios Co., Ltd.), which has two oscillators with an oscillation frequency of 50 kHz that are out of phase by 180° with respect to each other, and has an electrical output of 120 W. About 2 ml of Contaminon N is then added to the water tank.

(4) The beaker in (2) is set in a beaker fixing hole of the ultrasonic dispersing unit, and the ultrasonic dispersing unit is operated. Then, the height position of the beaker is adjusted so that the resonance state of the liquid level of the electrolytic aqueous solution in the beaker is at a maximum.

(5) About 10 mg of toner is in small amounts added to, and dispersed in, the electrolytic aqueous solution in the beaker of (4) while the electrolytic aqueous solution is being irradiated with ultrasonic waves. The ultrasonic dispersion treatment is continued for an additional 60 seconds. The temperature of water in the water tank is appropriately adjusted to 10° C. or more and 40° C. or less for the ultrasonic dispersion.

(6) The electrolytic aqueous solution of (5) having the toner dispersed therein is added dropwise using a pipette into the round-bottom beaker of (1) placed in the sample stand, and the measurement concentration is adjusted to about 5%. Measurement is performed until 50,000 particles are measured.

(7) The measurement data is analyzed with the dedicated software included with the apparatus, to calculate the weight average particle size (D4). The weight average particle size (D4) is the “average diameter” on the analysis/volume statistics (arithmetic average) screen when the dedicated software is set to graph/vol %.

<Measurement of the Glass Transition Temperature of the Resin>

The glass transition temperature of the resin is measured using the differential scanning calorimeter “Q1000” (manufactured by TA Instruments) according to ASTM D3418-82.

The temperature of the detection unit in the apparatus is corrected using the melting points of indium and zinc, and the amount of heat is corrected using the heat of fusion of indium.

Specifically, about 5 mg of resin is accurately weighed out and placed on an aluminum pan. Measurement is performed at a rate of temperature increase of 10° C./min over a measurement range of 30° C. to 200° C., using an empty aluminum pan as a reference. In the temperature increase process, a change in the specific heat is obtained in the temperature range of 40° C. to 100° C. The intersection between the line midway between the baselines of before and after the change in specific heat and the differential heat curve is taken as the glass transition temperature (Tg) of the resin.

### EXAMPLES

Although specific Examples of the present invention will now be described, the present invention is not limited to these Examples.

### Polyester Resin Production Example 1

75.0 parts by mass (0.167 parts by mole) of polyoxypropylene(2.2)-2,2-bis(4-hydroxyphenyl)propane, 24.0 parts by mass (0.145 parts by mole) of terephthalic acid and 0.5 parts by mass of titanium tetrabutoxide were charged into a 4-L four-necked flask made of glass. The flask was equipped with a thermometer, a stirring rod, a condenser and a nitrogen-introducing pipe, and was placed in a mantle heater. Next, the contents of the flask were purged with nitrogen gas, and then the temperature in the flask was gradually increased, under stirring. The reaction was left to proceed for 4 hours under stirring at a temperature of 200° C. (first reaction step). Thereafter, 2.0 parts by mass (0.010 parts by mole) of trimellitic anhydride were added, and the reaction was left to proceed for 2 hours at 180° C. (second reaction step), to obtain a polyester resin A-1.

The GPC molecular weights of the THF soluble component of the polyester resin A-1 were a weight average molecular weight (Mw) of 9,600, number average molecular weight (Mn) of 3,700 and peak molecular weight (Mp) of 4,400. The softening point (Tm) was 101° C. and the glass transition temperature (Tg) was 58° C.

### Styrene Resin Production Example 1

After charging 50 parts by mass of xylene into an autoclave and purging with nitrogen, the temperature was increased to 185° C. in a sealed state, under stirring. A mixed solution of 95 parts by mass of styrene, 5 parts by mass of n-butyl acrylate, 5 parts by mass of di-t-butyl peroxide and 20 parts by mass of xylene was continuously added dropwise for 3 hours while controlling the temperature in the autoclave at 185° C. for polymerization to proceed. The mixture was further maintained at the same temperature for 1 hour to complete the polymerization. The solvent was removed to obtain a styrene resin B-1. The obtained styrene resin B-1 had a weight average molecular weight (Mw) of 3,500, a softening point (Tm) of 96° C. and a glass transition temperature (Tg) of 58° C.

### Styrene Resin Production Example 2

Styrene resin B-2 was obtained in the same manner as in styrene resin production example 1, except that the temperature in the autoclave was changed to 200° C.

### Styrene Resin Production Example 3

Styrene resin B-3 was obtained in the same manner as in styrene resin production example 1, except that 90 parts by mass of styrene and 10 parts by mass of n-butyl acrylate were used, and that the temperature in the autoclave was changed to 175° C.

### Styrene Resin Production Example 4

Styrene resin B-4 was obtained in the same manner as in styrene resin production example 1, except that 88 parts by mass of styrene, 12 parts by mass of n-butyl acrylate and 6 parts by mass of di-t-butyl peroxide were used, and that the temperature in the autoclave was changed to 200° C.

### Styrene Resin Production Example 5

Styrene resin B-5 was obtained in the same manner as in styrene resin production example 1, except that 94 parts by mass of styrene, 6 parts by mass of n-butyl acrylate and 4 parts by mass of di-t-butyl peroxide were used, and that the temperature in the autoclave was changed to 170° C.

The physical properties of styrene resins B-1 to B-5 obtained in styrene resin production examples 1 to 5 are shown in Table 1.

TABLE 1
Styrene Resin Physical Properties

| | Mw | Tm (° C.) | Tg (° C.) |
|---|---|---|---|
| Styrene Resin B-1 | 3500 | 96 | 58 |
| Styrene Resin B-2 | 2000 | 80 | 49 |
| Styrene Resin B-3 | 5000 | 118 | 62 |
| Styrene Resin B-4 | 1800 | 76 | 48 |
| Styrene Resin B-5 | 5200 | 124 | 64 |

### Polymer C Production Example

| | |
|---|---|
| Polyethylene (Mw: 1,400, Mn: 850, endothermic | 20 parts by mass |
| peak in DSC: 100° C.) having at least one | |
| unsaturated bond | |
| Styrene | 59 parts by mass |
| n-Butyl acrylate | 18.5 parts by mass |
| Acrylonitrile | 2.5 parts by mass |

The above-described raw materials were charged into an autoclave, the system was purged with nitrogen, and the temperature was maintained at 180° C. while heating and stirring. 50 parts by mass of 2 mass % di-t-butyl peroxide in a xylene solution was continuously added dropwise into the system for 5 hours. The mixture was cooled, and then the solvent was removed by separation to obtain a polymer C-1 in which a copolymer was grafted to polyethylene. The polymer C-1 had a softening point (Tm) of 110° C. and a glass transition temperature (Tg) of 64° C. The THF soluble component of polymer C-1 had a weight average molecular weight (Mw) of 7,400 and a number average molecular weight (Mn) of 2,800.

### Toner Production Example 1

| | |
|---|---|
| Polyester resin A-1 | 90 parts by mass |
| Styrene resin B-1 | 10 parts by mass |
| Polymer C-1 | 2 parts by mass |
| Fischer-Tropsch wax (maximum endothermic peak | 5 parts by mass |
| temperature 78° C.) | |
| Carbon Black (number average particle size: 30 nm, | 5 parts by mass |
| DBP oil absorption: 50 ml/100 g, pH: 9.0) | |
| Aluminum 3,5-di-t-butyl-salicylate compound | 0.5 parts by mass |

The above-described formulation was mixed with a Henschel mixer (Model: FM-75, manufactured by Mitsui Miike Chemical Engineering Machinery Co., Ltd.), and then the mixture was kneaded with an open roll type continuous kneader (manufactured by Mitsui Mining Co., Ltd., trade name: Kneadex) under conditions of a rotation speed of 1.0 s⁻¹ and a dwell time of about 2 minutes. The obtained kneaded product was cooled, and coarsely pulverized with a hammer mill so as to be 1 mm or less to obtain a coarsely pulverized product. The obtained coarsely pulverized product was finely pulverized with a mechanical mill (T-250, manufactured by Freund-Turbo Corporation). The finely pulverized product was then classified using a rotary classifier (200TSP, manufactured by Hosokawa Micron Corporation) to obtain toner particles 1. The classification was carried out under operating conditions of the rotary classifier (200TSP, manufactured by Hosokawa Micron Corporation) of a classification rotor rotation speed of 50.0 s⁻¹. The obtained toner particles 1 had a weight average particle size (D4) of 5.8 μm.

The toner particles were surface-treated with the surface heat-treatment apparatus illustrated in FIG. 1. The general configuration and operating conditions of the surface heat-treatment apparatus are as follows.

The inner diameter of the surface heat-treatment apparatus was set to 450 mm and the outer diameter of the cylindrical pole was set to 200 mm. The hot-air supply unit outlet portion had an inner diameter of 200 mm and an outer diameter of 300 mm. Hot air was introduced into the treatment chamber via rectification blades (angle 50°, blade thickness 1 mm, number of blades: 36). The first cold-air supply unit had an inner diameter of 350 mm and an outer diameter of 450 mm.

In the present Examples, the raw-material supply unit and the first nozzle are integrally configured, and a jacket is provided therearound. Further, the ridge line angle of the first nozzle is set at 40°, the ridge line angle of the second nozzle is set at 60°. A rib is provided at an outer peripheral surface of the second nozzle, and a return portion is provided at a lower edge portion. The angle of the return portion to the ridge line was 140°. The outer diameter of the raw-material supply unit was 150 mm.

The operating conditions of the surface heat-treatment apparatus were a raw-material feed rate (F) of 15 kg/hr, a hot-air temperature (T1) of 200° C., a hot-air flow rate (Q1) of 8.0 m³/min, a first cold-air total rate (Q2) of 4.0 m³/min, a second cold-air total rate (Q3) of 1.0 m³/min, a third cold-air total rate (Q4) of 1.0 m³/min, a pole cold-air total rate (Q5) of 0.5 m³/min, a compressed gas blow rate (IJ) of 1.6 m³/min, a blower rate (Q6) of 23.0 m³/min and a cold-air absolute moisture content of 3 g/m³. The obtained toner particles 1 had an average circularity of 0.965 and a weight average particle size (D4) of 6.2 μm.

100 parts by mass of the obtained toner particles 1, 0.8 parts by mass of hydrophobic silica fine particles having a BET specific surface area of 130 m²/g that had been surface-treated with 20 mass % hexamethyldisilazane, and 1.0 part by mass of hydrophobic silica fine particles having a BET specific surface area of 25 m²/g that had been surface-treated with 4 mass % hexamethyldisilazane were mixed, and charged into a Henschel mixer (Model: FM-75, manufactured by Mitsui Miike Chemical Engineering Machinery Co., Ltd.). The mixture was mixed in the Henschel mixer at a rotation speed of 30 s⁻¹ and a mixing time of 12 min to obtain toner 1. Toner 1 had an average circularity of 0.965 and a weight average particle size (D4) of 6.2 μm.

### Toner Production Example 2

Toner 2 was obtained in the same manner as in toner production example 1, except that the amount of the Fischer-Tropsch wax was changed to 10 parts by mass.

### Toner Production Example 3

Toner 3 was obtained in the same manner as in toner production example 1, except that the wax was changed to an ester wax (maximum endothermic peak temperature 75° C.)

### Toner Production Example 4

Toner 4 was obtained in the same manner as in toner production example 1, except that the polymer C-1 was not used.

### Toner Production Example 5

Toner 5 was obtained in the same manner as in toner production example 1, except that the amount of the polymer C-1 added was changed to 10 parts by mass.

### Toner Production Example 6

Toner 6 was obtained in the same manner as in toner production example 1, except that the hot-air temperature during the hot-air surface treatment was changed to 100° C.

### Toner Production Example 7

Toner 7 was obtained in the same manner as in toner production example 1, except that the hot-air temperature during the hot-air surface treatment was changed to 300° C.

### Toner Production Example 8

Toner 8 was obtained in the same manner as in toner production example 1, except that the styrene resin was changed to B-3.

### Toner Production Example 9

Toner 9 was obtained in the same manner as in toner production example 1, except that the styrene resin was changed to B-4.

### Toner Production Example 10

Toner 10 was obtained in the same manner as in toner production example 1, except that the amount of the polyester resin A was changed to 98 parts by mass, and the amount of the styrene resin B-1 was changed to 2 parts by mass.

### Toner Production Example 11

Toner 11 was obtained in the same manner as in toner production example 1, except that the amount of the polyester resin A was changed to 85 parts by mass, and the amount of the styrene resin B-1 was changed to 15 parts by mass.

### Toner Production Example 12

Toner 12 was obtained in the same manner as in toner production example 1, except that the cold-air absolute moisture content during the hot-air surface treatment was changed to 10 g/m³.

### Toner Production Example 13

Toner 13 was obtained in the same manner as in toner production example 1, except that the formulation was changed to the following.

| | |
|---|---|
| Polyester resin A-1 | 100 parts by mass |
| Polymer C-1 | 2 parts by mass |
| Fischer-Tropsch wax (maximum endothermic | 5 parts by mass |
| peak temperature 78° C.) | |
| Carbon Black (number average particle size: 30 nm, | 5 parts by mass |
| DBP oil absorption: 50 ml/100 g, pH: 9.0) | |
| Aluminum 3,5-di-t-butyl-salicylate compound | 0.5 parts by mass |

### Toner Production Example 14

Toner 14 was obtained in the same manner as in toner production example 1, except that the hot-air surface treatment was not carried out.

### Toner Production Example 15

Toner 15 was obtained in the same manner as in toner production example 1, except that the amount of the polyester resin A was changed to 99 parts by mass, and the amount of the styrene resin B-1 was changed to 1 part by mass.

### Toner Production Example 16

Toner 16 was obtained in the same manner as in toner production example 1, except that the amount of the polyester resin A was changed to 84 parts by mass, and the amount of the styrene resin B-1 was changed to 16 parts by mass.

### Toner Production Example 17

Toner 17 was obtained in the same manner as in toner production example 1, except that the styrene resin was changed to B-4.

### Toner Production Example 18

Toner 18 was obtained in the same manner as in toner production example 1, except that the styrene resin was changed to B-5.

The obtained toners 1 to 18 are shown in Table 2.

TABLE 2

| | | | | | Hot-Air | Cold-Air | | | | | | | |
|---|---|---|---|---|---|---|---|---|---|---|---|---|---|
| | | | | Blend | Temper- | Moisture | | Parts | | Parts | | | Average |
| | Polyester | Styrene | | Ratio | ature | Content | | by | | by | T/ | D4 | Circu- |
| | Resin A | Resin B | Mw | A/B | (° C.) | (g/m³) | Polymer C | Mass | Wax | Mass | W | (μm) | larity |
| Toner 1 | resin A-1 | resin B-1 | 3500 | 90/10 | 200 | 3 | Polymer C-1 | 2 | Fischer-Tropsch wax | 5 | 2.4 | 6.2 | 0.965 |
| Toner 2 | resin A-1 | resin B-1 | 3500 | 90/10 | 200 | 3 | Polymer C-1 | 2 | Fischer-Tropsch wax | 10 | 1.2 | 6.2 | 0.965 |
| Toner 3 | resin A-1 | resin B-1 | 3500 | 90/10 | 200 | 3 | Polymer C-1 | 2 | Ester wax | 5 | 2.4 | 6.3 | 0.963 |
| Toner 4 | resin A-1 | resin B-1 | 3500 | 90/10 | 200 | 3 | None | None | Fischer-Tropsch wax | 5 | 2.0 | 6.2 | 0.967 |
| Toner 5 | resin A-1 | resin B-1 | 3500 | 90/10 | 200 | 3 | Polymer C-1 | 10 | Fischer-Tropsch wax | 5 | 4.0 | 6.2 | 0.962 |
| Toner 6 | resin A-1 | resin B-1 | 3500 | 90/10 | 100 | 3 | Polymer C-1 | 2 | Fischer-Tropsch wax | 5 | 2.4 | 6.1 | 0.950 |
| Toner 7 | resin A-1 | resin B-1 | 3500 | 90/10 | 300 | 3 | Polymer C-1 | 2 | Fischer-Tropsch wax | 5 | 2.4 | 6.6 | 0.980 |
| Toner 8 | resin A-1 | resin B-2 | 2000 | 90/10 | 200 | 3 | Polymer C-1 | 2 | Fischer-Tropsch wax | 5 | 2.4 | 6.2 | 0.966 |
| Toner 9 | resin A-1 | resin B-3 | 5000 | 90/10 | 200 | 3 | Polymer C-1 | 2 | Fischer-Tropsch wax | 5 | 2.4 | 6.2 | 0.964 |
| Toner 10 | resin A-1 | resin B-1 | 3500 | 98/2 | 200 | 3 | Polymer C-1 | 2 | Fischer-Tropsch wax | 5 | 0.8 | 6.2 | 0.966 |
| Toner 11 | resin A-1 | resin B-1 | 3500 | 85/15 | 200 | 3 | Polymer C-1 | 2 | Fischer-Tropsch wax | 5 | 3.4 | 6.2 | 0.963 |
| Toner 12 | resin A-1 | resin B-1 | 3500 | 90/10 | 200 | 10 | Polymer C-1 | 2 | Fischer-Tropsch wax | 5 | 2.4 | 6.2 | 0.966 |
| Toner 13 | resin A-1 | None | None | 100/0 | 200 | 3 | Polymer C-1 | 2 | Fischer-Tropsch wax | 5 | 0.4 | 6.3 | 0.965 |
| Toner 14 | resin A-1 | resin B-1 | 3500 | 90/10 | None | — | Polymer C-1 | 2 | Fischer-Tropsch wax | 5 | 2.4 | 6.0 | 0.945 |
| Toner 15 | resin A-1 | resin B-1 | 3500 | 99/1 | 200 | 3 | Polymer C-1 | 2 | Fischer-Tropsch wax | 5 | 0.6 | 6.2 | 0.965 |
| Toner 16 | resin A-1 | resin B-1 | 3500 | 84/16 | 200 | 3 | Polymer C-1 | 2 | Fischer-Tropsch wax | 5 | 3.6 | 6.2 | 0.964 |
| Toner 17 | resin A-1 | resin B-4 | 1800 | 90/10 | 200 | 3 | Polymer C-1 | 2 | Fischer-Tropsch wax | 5 | 2.4 | 6.2 | 0.966 |
| Toner 18 | resin A-1 | resin B-5 | 5200 | 90/10 | 200 | 3 | Polymer C-1 | 2 | Fischer-Tropsch wax | 5 | 2.4 | 6.2 | 0.965 |

### Example 1

Magnetic ferrite carrier particles (number average particle size 35 μm) surface-coated with a silicone resin and the toner particles 1 were mixed so that the toner concentration was 6 mass % to obtain a two-component developer 1.

Using the obtained two-component developer 1, the following evaluation tests were carried out.

<Fixability (Low-Temperature Fixability and High-Temperature Offset Resistance) Evaluation>

Under an ordinary-temperature, ordinary-humidity environment (23° C./50 to 60%), a fixing test was carried out using a full color copying machine imagePress C7010VP manufactured by Canon, Inc., that had been modified so that the fixing temperature and the sheet conveyance rate could be freely set. In single color mode, the amount of toner applied on the sheet was adjusted to 1.2 mg/cm², and an unfixed image was produced. An image was formed on the evaluation paper at an image printing ratio of 25% using A4-sized plain paper (CS-814 (grammage 81.4 g/m², sold by Canon Marketing Japan Inc.)) as the evaluation paper. Next, the unfixed image on the evaluation paper was fixed by setting the sheet conveyance rate to 450 mm/sec (corresponding to 105 sheets per minute), and increasing the fixing temperature in 5° C. intervals from 120° C. A temperature difference between the fixing lower limit temperature, which is the temperature at which low-temperature offset does not occur, and the fixing upper limit temperature, which is the temperature at which high-temperature offset does not occur, was set as the fixable range. If wraparound occurred before high-temperature offset occurred, increasing the temperature was stopped, and that temperature was set as the fixing upper limit temperature. The evaluation results are shown in Table 4.

(Evaluation Criteria for Fixing Lower Limit Temperature)

A: Less than 155° C. (very good)
B: 155° C. or more and less than 165° C. (good)
C: 165° C. or more and less than 175° C. (acceptable level in the present invention)
D: 175° C. or more (unacceptable in the present invention)

(Evaluation Criteria for Fixing Upper Limit Temperature)

A: 200° C. or more (very good)
B: 190° C. or more and less than 200° C. (good)
C: 180° C. or more and less than 190° C. (acceptable level in the present invention)
D: Less than 180° C. (unacceptable in the present invention)

<Evaluation of Fixability (Image Glossiness)>

Glossiness was evaluated based on a gloss value obtained by measuring at a single angle of 60° for an unfixed image produced according to the above-described fixability evaluation and a fixed image fixed under conditions 10° C. higher than the above-described fixing lower limit temperature using a Handy gloss-meter (“PG-1M” manufactured by Tokyo Denshoku Co., Ltd.).

(Evaluation Criteria)

A: 16.0% or more (very good)
B: 12.0% or more and less than 16.0% (good)
C: 8% or more and less than 12.0% (acceptable level in the present invention)
D: Less than 8% (unacceptable in the present invention)

<Evaluation of Fixability (Ability to Handle Mixed Media Loads)>

An image was formed in the same manner as in the above-described fixability evaluation, except that the evaluation paper was changed to A4-sized thick paper (Color Copy (grammage 350 g/m², manufactured by Mondi)), and the following evaluation was carried out. The evaluation results are shown in Table 4.

Evaluation of the ability to handle mixed media loads was carried out based on the following criteria.

A: Difference between fixing lower limit temperature of the above-described thick paper and the fixing upper limit temperature of the above-described plain paper of 20° C. or more. (excellent)
B: Difference between fixing lower limit temperature of the above-described thick paper and the fixing upper limit temperature of the above-described plain paper of 10° C. or more and less than 20° C. (good)
C: Difference between fixing lower limit temperature of the above-described thick paper and the fixing upper limit temperature of the above-described plain paper of 0° C. or more and less than 10° C. (level that is not a problem in the present invention)
D: Difference between fixing lower limit temperature of the above-described thick paper and the fixing upper limit temperature of the above-described plain paper of less than 0° C. (unacceptable in the present invention)

<Evaluation of Fixing Wraparound Resistance>

Using the evaluation machine used in the above fixability evaluation, and starting from a position 1 mm from the end of the evaluation paper, an unfixed image (amount of applied toner 1.2 mg/cm²) 60 mm long in the sheet-passage direction was formed on the evaluation paper. Ten evaluation sample sheets carrying the same unfixed image were produced. As the evaluation paper, GF-500 (A4, grammage 64.0 g/m², sold by Canon Marketing Japan Inc.) was used.

The fixing temperature was set to 180° C., ten sheets were continuously passed through the apparatus at a sheet conveyance rate of 450 mm/sec (corresponding to 105 sheets per minute), and the occurrence of fixing wraparound was checked. The evaluation results are shown in Table 4.

A: No fixing wraparound occurs at all even without relying on the fixing separation claw. (excellent)
B: Sheets can be separated with the fixing separation claw, and there are no streaks in the fixed image, presenting no problem. (good)
C: Although sheets can be separated with the fixing separation claw, a few streaks in the fixed image. (level that is not a problem in the present invention)
D: Sheets cannot be separated with the fixing separation claw, and jams occurs. (unacceptable in the present invention)

<Durability Evaluation>

Evaluation was carried out using a modified full color copying machine imagePress C7010VP manufactured by Canon, Inc., as the image forming apparatus, and placing the above-described two-component developer 1 in the developing unit at the black position.

Under an ordinary-temperature, ordinary-humidity environment (N/N (23° C., 60% RH)), and a high-temperature, high-humidity environment (H/H (32.5° C., 80% RH)), an image output durability test was carried out (A4 landscape, 1% printing ratio, 1,000 sheets continuously passed). Plain paper (CS-814 (grammage 81.4 g/m²), sold by Canon Marketing Japan Inc.) was used as the evaluation paper. In the above-described evaluation environment, the amount of toner applied on an FFH image (solid portion) was adjusted to 0.6 mg/cm². An FFH image is an image in which 256 gradations are expressed in hexadecimal notation, with OOH expressing the first gradation (white background) and FFH expressing the 256-th gradation (solid portion). During the period of continuously passing 1,000 sheets, the sheet passing was carried out under the same development and transfer conditions as the first sheet (no calibration).

(White Streak Measurement after Passing 1,000 Sheets)

After continuously passing 1,000 sheets, a 40H image (64-th gradation) was output, and the white streaks of the image were evaluated based on the following criteria.

(Evaluation Criteria)

A: No image white streaks occurs at all (excellent)
B: 1 or more and 5 or less white streaks having a width of less than 0.5 mm occurs, and no white streaks having a width of 1.0 mm or more occurs (good)
C: 6 or more and 10 or less white streaks having a width of less than 0.5 mm occurs, or 1 or more and 10 or less white streaks having a width of 0.5 mm or more and less than 1.0 mm occurs (level that is not a problem in the present invention)
D: 11 or more white streaks having a width of less than 1.0 mm occurs, or 1 or more white streaks having a width of 1.0 mm or more occurs (unacceptable in the present invention)

### Examples 2 to 13 and Comparative Examples 1 to 6

Evaluation was performed under the same setting conditions and in the same manner as in Example 1, except that a two-component developer was used in which the toner was changed to the toner shown in Table 3. The Evaluation results are shown in Table 4.

TABLE 3

| | Toner No. | Carrier No. | Two-component Developer No. |
|---|---|---|---|
| Example 1 | Toner 1 | Carrier 1 | Two-component Developer 1 |
| Example 2 | Toner 2 | Carrier 1 | Two-component Developer 2 |
| Example 3 | Toner 3 | Carrier 1 | Two-component Developer 3 |
| Example 4 | Toner 4 | Carrier 1 | Two-component Developer 4 |
| Example 5 | Toner 5 | Carrier 1 | Two-component Developer 5 |
| Example 6 | Toner 6 | Carrier 1 | Two-component Developer 6 |
| Example 7 | Toner 7 | Carrier 1 | Two-component Developer 7 |
| Example 8 | Toner 8 | Carrier 1 | Two-component Developer 8 |
| Example 9 | Toner 9 | Carrier 1 | Two-component Developer 9 |
| Example 10 | Toner 10 | Carrier 1 | Two-component Developer 10 |
| Example 11 | Toner 11 | Carrier 1 | Two-component Developer 11 |
| Example 12 | Toner 12 | Carrier 1 | Two-component Developer 12 |
| Comparative | Toner 13 | Carrier 1 | Two-component Developer 13 |
| Example 1 | | | |
| Comparative | Toner 14 | Carrier 1 | Two-component Developer 14 |
| Example 2 | | | |
| Comparative | Toner 15 | Carrier 1 | Two-component Developer 15 |
| Example 3 | | | |
| Comparative | Toner 16 | Carrier 1 | Two-component Developer 16 |
| Example 4 | | | |
| Comparative | Toner 17 | Carrier 1 | Two-component Developer 17 |
| Example 5 | | | |
| Comparative | Toner 18 | Carrier 1 | Two-component Developer 18 |
| Example 6 | | | |

TABLE 4

| | | Plain | | Plain | | Plain | | | | | | | |
|---|---|---|---|---|---|---|---|---|---|---|---|---|---|
| | | Paper | | Paper | | Paper | | Thick Paper | | | Fixing | | |
| | | Low-Tem- | | Hot Off- | | Image | | Low-Tem- | Media | | Wrap- | | |
| | | perature | | set Re- | | Glossi- | | perature | Mix- | | around | White | White |
| | | Fixability | | sistance | | ness | | Fixability | ability | | Resis- | Streaks | Streaks |
| | | [° C.] | Rank | [° C.] | Rank | [%] | Rank | [° C.] | [° C.] | Rank | tance | N/N | H/H |
| Example 1 | Two-component | 145 | A | 200 | A | 18.0 | A | 160 | 40 | A | A | A | A |
| | Developer 1 | | | | | | | | | | | | |
| Example 2 | Two-component | 145 | A | 200 | A | 19.0 | A | 160 | 40 | A | A | C | C |
| | Developer 2 | | | | | | | | | | | | |
| Example 3 | Two-component | 150 | A | 180 | C | 13.0 | B | 170 | 10 | C | B | A | A |
| | Developer 3 | | | | | | | | | | | | |
| Example 4 | Two-component | 145 | A | 190 | B | 11.0 | C | 170 | 20 | B | B | B | B |
| | Developer 4 | | | | | | | | | | | | |
| Example 5 | Two-component | 155 | B | 190 | B | 17.0 | A | 175 | 15 | B | C | A | A |
| | Developer 5 | | | | | | | | | | | | |
| Example 6 | Two-component | 145 | A | 180 | C | 16.0 | A | 170 | 10 | C | C | A | A |
| | Developer 6 | | | | | | | | | | | | |
| Example 7 | Two-component | 145 | A | 200 | A | 17.0 | A | 160 | 40 | A | B | C | C |
| | Developer 7 | | | | | | | | | | | | |
| Example 8 | Two-component | 150 | A | 200 | A | 18.0 | A | 165 | 35 | A | B | C | C |
| | Developer 8 | | | | | | | | | | | | |
| Example 9 | Two-component | 170 | C | 185 | C | 13.0 | B | 180 | 5 | C | B | B | B |
| | Developer 9 | | | | | | | | | | | | |
| Example 10 | Two-component | 160 | B | 180 | C | 17.0 | A | 175 | 5 | C | B | A | A |
| | Developer 10 | | | | | | | | | | | | |
| Example 11 | Two-component | 170 | C | 195 | B | 12.5 | B | 180 | 15 | B | B | B | B |
| | Developer 11 | | | | | | | | | | | | |
| Example 12 | Two-component | 150 | A | 180 | C | 14.0 | B | 170 | 10 | C | C | A | A |
| | Developer 12 | | | | | | | | | | | | |
| Comparative | Two-component | 160 | B | 170 | D | 18.0 | A | 175 | −5 | D | C | B | B |
| Example 1 | Developer 13 | | | | | | | | | | | | |
| Comparative | Two-component | 160 | B | 170 | D | 13.0 | B | 175 | −5 | D | C | A | A |
| Example 2 | Developer 14 | | | | | | | | | | | | |
| Comparative | Two-component | 160 | B | 170 | D | 17.0 | A | 175 | −5 | D | C | B | B |
| Example 3 | Developer 15 | | | | | | | | | | | | |
| Comparative | Two-component | 175 | D | 195 | B | 11.0 | C | 190 | 5 | B | B | B | B |
| Example 4 | Developer 16 | | | | | | | | | | | | |
| Comparative | Two-component | 150 | A | 200 | A | 19.0 | A | 165 | 35 | A | B | D | D |
| Example 5 | Developer 17 | | | | | | | | | | | | |
| Comparative | Two-component | 175 | D | 175 | D | 11.0 | C | 185 | −10 | D | B | B | B |
| Example 6 | Developer 18 | | | | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-102021, filed on Apr. 27, 2012, which is hereby incorporated by reference herein in its entirety.

1-8. (canceled)

9. A method of producing a toner comprising toner particles and fine inorganic particles on a surface of the toner particles, the method comprising:
mixing a raw material which contains a binder resin, a colorant, and a wax, to obtain a mixed material;
melt kneading the mixed material to obtain a resin composition;
cooling the resin composition to obtain a cooled product;
pulverizing the cooled product to obtain a pulverized product;
classifying the pulverized product to obtain a classified product; and
treating a surface of the classified product by hot air to obtain the toner particles,
wherein:
the binder resin contains a polyester resin A and a styrene resin B;
a content ratio AB of the polyester resin A and the styrene resin B is 85/15 or more and 98/2 or less based on mass;
the styrene resin B is obtained by polymerization of monomers consisting of a styrene and a n-butyl acrylate; and
a tetrahydrofuran soluble component of the styrene resin B contained in the binder resin has a weight average molecular weight Mw of 2,000 or more and 5,000 or less.

10. The method according to claim 9, wherein the raw material further contains a polymer C having a structure in which a vinyl resin component and a hydrocarbon compound are linked.

11. The method according to claim 10, wherein the polymer C is a polymer having a structure in which a vinyl resin component is graft-polymerized to polyethylene.

12. The method according to claim 10, wherein a content of the polymer C is 2 parts by mass or more and 10 parts by mass or less based on 100 parts by mass of the binder resin.

13. The method according to claim 9, wherein the polyester resin A has a peak molecular weight Mp of a tetrahydrofuran soluble component of 2,500 or more and 6,000 or less.

14. The method according to claim 9, wherein the polyester resin A has a glass transition temperature of 40° C. or more and less than 70° C.

15. The method according to claim 9, wherein the toner has an average circularity of 0.950 or more and 0.980 or less.

16. The method according to claim 9, wherein the hot air is 100° C. or more and 450° C. or less.

17. The method according to claim 9, wherein the binder resin consists of the polyester resin A and the styrene resin B.
